(19) United States
(12) Patent Application Publication
(10) Pub. No.: US 2025/0337479 A1
(43) Pub. Date: Oct. 30, 2025

(54) METHOD AND APPARATUS FOR DETERMINING SATELLITE TYPE OF CELL

(71) Applicant: Beijing Xiaomi Mobile Software Co., Ltd., Beijing (CN)

(72) Inventor: Xuhua TAO, Beijing (CN)

(21) Appl. No.: 18/711,016

(22) PCT Filed: Nov. 22, 2021
(86) PCT No.: PCT/CN2021/132168

§ 371 Date: May 16, 2024

(51) Int. Cl. H04B 7/185; H04W 24/08

(52) U.S. Cl. CPC H04B 7/18513; H04W 24/08

(57) ABSTRACT

A method and apparatus for determining the satellite type of a cell. The method for determining the satellite type of a cell includes: acquiring indication information; and determining, according to the indication information, the satellite type of a serving cell where a terminal device is located, and the satellite type of a neighboring cell.

### BACKGROUND OF THE INVENTION

In a satellite communication system, satellites located in different orbits exist, such as a geostationary earth orbiting (GEO), a medium earth orbiting (MEO), and a low earth orbiting (LEO).

### SUMMARY OF THE INVENTION

An example of the disclosure provides a method and apparatus for determining a satellite type of a cell. An example of the disclosure provides a method for determining a satellite type of a cell, performed by a terminal device, and including: acquiring indication information; and determining satellite types of a serving cell and a neighboring cell where the terminal device is located through the indication information.

An example of the disclosure provides a method for determining a satellite type of a cell, performed by a network device, and including: sending indication information to a terminal device, where, the indication information indicate satellite types of a serving cell and a neighboring cell where the terminal device is located. An example of the disclosure provides a communication apparatus. The communication apparatus including one or more processors and a memory, and the one or more processors is/are configured to: acquire indication information; and determine satellite types of a serving cell and a neighboring cell where a terminal device is located according to the indication information.

An example of the disclosure provides a non-transitory computer readable storage medium, configured to store instructions for the above terminal device, and when the instructions are executed, the terminal device executes the method performed by the terminal device above.

An example of the disclosure provides a non-transitory computer readable storage medium, configured to store instructions for the above network device, and when the instructions are executed, the network device executes the method performed by the network device above.

### BRIEF DESCRIPTION OF DRAWINGS

In order to more clearly illustrate technical solutions of examples in the disclosure or in the background art, the accompanying drawings needed by the examples of the disclosure or the background art will be illustrated below.

FIG. 1 is a schematic architecture diagram of a communication system provided by an example of the disclosure.

FIG. 2 is a schematic flow diagram of a method for determining a satellite type of a cell provided by an example of the disclosure.

FIG. 3 is a schematic flow diagram of a method for determining a satellite type of a cell provided by an example of the disclosure.

FIG. 4 is a schematic flow diagram of a method for determining a satellite type of a cell provided by an example of the disclosure.

FIG. 5 is a schematic flow diagram of a method for determining a satellite type of a cell provided by an example of the disclosure.

FIG. 6 is a schematic flow diagram of a method for determining a satellite type of a cell provided by an example of the disclosure.

FIG. 7 is a schematic flow diagram of a method for determining a satellite type of a cell provided by an example of the disclosure.

FIG. 8 is a schematic flow diagram of a method for determining a satellite type of a cell provided by an example of the disclosure.

FIG. 9 is a schematic structural diagram of an apparatus for determining a satellite type of a cell provided by an example of the disclosure.

FIG. 10 is a schematic structural diagram of a communication apparatus provided by an example of the disclosure.

FIG. 11 is a schematic structural diagram of a chip provided by an example of the disclosure.

### DETAILED DESCRIPTION OF THE INVENTION

Examples will be illustrated in detail here, and their instances are represented in the accompanying drawings. Unless otherwise indicated, when the following description refers to the accompanying drawings, the same number in the different accompanying drawings represents the same or similar elements. Implementations described in the following examples do not represent all implementations consistent with the examples of the present disclosure. Rather, they are merely examples of an apparatus and method consistent with some aspects of the examples of the present disclosure as detailed in appended claims.

It needs to be understood that “a plurality of” in the present disclosure refers to two or more than two, and other quantifiers are similar to this. “And/or” describes an association relationship of associated objects, and represents that three relationships may exist, for example, A and/or B may represent that A exists separately, A and B exist at the same time, and B exists separately. A character “/” generally represents that associated objects front and back are in an “or” relationship. Singular forms “one”, “said” and “the” are also intended to include plural forms, unless the context clearly indicates other meaning otherwise.

It needs to be understood that although the terms first, second, third, etc. may be used to describe various pieces of information in the examples of the disclosure, such information will not be limited to these terms. These terms are merely used to distinguish the same type of information from each other. For example, without departing from the scope of the examples of the disclosure, first information may also be referred to as second information, and similarly, the second information may also be referred to as the first information. Depending on the context, the word “if” as used here may be interpreted as “at the time” or “when” or “in response to determining”.

The disclosure relates to the technical field of communication, in particular to a method and apparatus for determining a satellite type of a cell.

In a satellite communication system, satellites located in different orbits exist, such as a geostationary earth orbiting (GEO), a medium earth orbiting (MEO), and a low earth orbiting (LEO). A terminal device possibly needs different radio resource management (RRM) and radio link monitoring (RLM) measurement requirements when connecting the satellites in different orbits, however, an effective means for determining types of the connected satellites is scarce at present.

The terms involved in the disclosure are described first for facilitating understanding.

### 1, Radio Resource Management (RRM)

The RRM may provide service quality assurance for wireless user terminals in a network under the condition of a limited bandwidth, and its basic starting point is to improve a utilization rate of a wireless spectrum furthest, prevent network congestion, and keep signaling loads as small as possible by flexibly distributing and dynamically adjusting available resources of a wireless transmission part and the network under the condition of uneven distribution of network traffic and fluctuation of channel characteristics due to channel attenuation and interference.

2, radio Link Monitoring (RLM)

A terminal device monitors the downlink wireless link quality of a main cell, and the action of indicating a non-synchronous/synchronous state to a higher layer is called the RLM. A resource configured to monitore a wireless link may be a single side band (SSB) signal, may also be a channel state information reference signal (CSI-RS), and may also be the both for use at the same time.

### 3, Cell

In a cellular mobile communication system, the cell is a region covered by one of a base station or a part (fan antenna) of the base station, and in this region, a mobile station may be in communication with the base station reliably through a wireless channel.

In a satellite communication system, the cell is a region covered by a radio wave emitted by one of satellites, and in this region, a radio communication station may use the satellite as a relay for communication.

In order to better understand the method for determining the satellite type of the cell disclosed by the example of the disclosure, a communication system applicable to the example of the disclosure is described first below.

Please refer to FIG. 1, which is a schematic architecture diagram of a communication system provided by an example of the disclosure. The communication system may include but is not limited to a network device and a terminal device. The quantity and form of devices shown in FIG. 1 are used for illustration and do not constitute limitations to the example of the disclosure, and two or more than two network devices and two or more than two terminal devices may be included in actual application. The communication system shown in FIG. 1 takes an example of including a network device 101 and a terminal device 102.

It needs to be noted that the technical solution of the example of the disclosure may be performed by various communication systems. For example, a long term evolution (LTE) system, a 5th generation (5G) mobile communication system, a 5G new radio (NR) system, or other future novel mobile communication systems.

The network device 101 in the example of the disclosure is an entity of a network side for emitting or receiving signals. For example, the network device 101 may be an evolved NodeB (cNB), a transmission reception point (TRP), a next generation NodeB (gNB) in an NR system, base stations in other future mobile communication systems or an access node in a wireless fidelity (WiFi) system, etc. The example of the disclosure does not limit the specific technology and specific device form adopted by the network device. The network device provided by the example of the disclosure may be composed of a central unit (CU) and a distributed unit (DU), the CU may also be called a control unit, adopting a CU-DU structure may separate the network device, for example, a protocol layer of a base station, part of functions of the protocol layer are centrally controlled in the CU, the remaining part or all functions of the protocol layer are distributed in the DU, and the CU centrally controls the DU.

The terminal device 102 in the example of the disclosure is an entity of a user side for emitting or receiving signals. For example, a mobile phone. The terminal device may also be called a terminal, user equipment (UE), a mobile station (MS), a mobile terminal (MT), etc. The terminal device may be an automobile having a communication function, a smart car, a mobile phone, a wearable device, a pad, a computer with a wireless transceiving function, a virtual reality (VR) terminal device, an augmented reality (AR) terminal device, a wireless terminal device in industrial control, a wireless terminal device in self-driving, a wireless terminal device in a remote medical surgery, a wireless terminal device in a smart grid, a wireless terminal device in transportation safety, a wireless terminal device in a smart city, a wireless terminal device in a smart home, etc. The example of the disclosure does not limit the specific technology and specific device form adopted by the terminal device.

It may be understood that the communication system described in the example of the disclosure is intended to explain the technical solution of the example of the disclosure more clearly, and does not constitute limitations to the technical solution provided by the example of the disclosure. Those ordinarily skilled in the art may know that with the evolution of a system architecture and emergence of a new service scene, the technical solution provided by the example of the disclosure is similarly applicable to similar technical problems.

It may be understood that the plurality of solutions in the example of the disclosure may be implemented separately or combined together, which is not limited in the disclosure.

The method and apparatus for determining the satellite type of the cell provided by the disclosure are introduced in detail below in conjunction with the accompanying drawings.

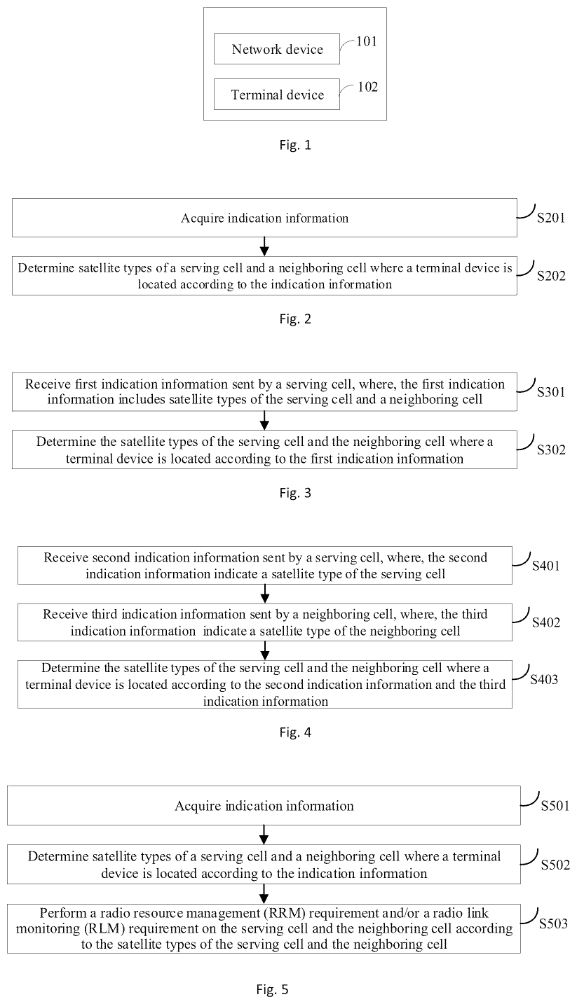

FIG. 2 is a schematic flow diagram of a method for determining a satellite type of a cell provided by an example of the disclosure. The method is performed by a terminal device, and as shown in FIG. 2, the method includes:

S201, indication information is acquired.

The indication information is used for determining satellite types of a serving cell and a neighboring cell where the terminal device is located.

Alternatively, the indication information may simultaneously and jointly indicate the satellite types of the serving cell and the neighboring cell, and may also correspondingly and separately indicate the satellite types of the serving cell and the neighboring cell.

Alternatively, the indication information may be sent by the serving cell, and may also be sent by the serving cell and the neighboring cell separately.

In some implementations, the indication information is sent by the serving cell, and the indication information sent by the serving cell includes the satellite types of the serving cell and the neighboring cell.

In some other implementations, the indication information is sent by the serving cell and the neighboring cell separately, the indication information sent by the serving cell includes the satellite type of the serving cell, and the indication information sent by the neighboring cell includes the satellite type of the neighboring cell.

Alternatively, the serving cell may send different pieces of indication information according to a connection state of the terminal device. For example, when the terminal device is in an idle state, a system information block (SIB) message broadcasted by the serving cell may be received, when the terminal device is in the connection state, a measurement object sent by the serving cell may be received, that is, the serving cell may send the indication information through IE “MeasObjectNR”.

S202, according to the indication information, the satellite types of the serving cell and the neighboring cell where the terminal is located are determined.

Alternatively, the indication information includes a mapping relation between the different cells and the satellite types, and according to the mapping relation, the satellite types of the serving cell and the neighboring cell where the terminal device is located may be determined.

In some implementations, the different cells include the serving cell and/or the neighboring cell. In some other implementations, the different cells may include cells under a carrier where the serving cell is located and/or cells under a carrier where the neighboring cell is located.

Alternatively, the satellite types include a geostationary earth orbiting (GEO), a medium earth orbiting (MEO), a low earth orbiting (LEO), and a high altitude platform station (HAPS).

In some implementations, the satellite type of the serving cell and the satellite type of the neighboring cell may be the same, for example, the satellite type of the serving cell may be the GEO, and the satellite type of the neighboring cell may be the GEO.

In some other implementations, the satellite type of the serving cell and the satellite type of the neighboring cell may be different, for example, the satellite type of the serving cell may be the GEO, and the satellite type of the neighboring cell may be the MEO.

The example of the disclosure provides the method for determining the satellite type of the cell, through the indication information, the satellite types of the serving cell and the neighboring cell where the terminal device is located are acquired, and matching processing of the serving cell and the neighboring cell with the respective satellite types may be performed based on the respective satellite types.

Alternatively, based on the satellite types, RRM and/or RLM measurement requirements are determined. For example, since orbit heights of different satellite types are different, some types of satellites will generate relative moving with the ground, causing that timing requirements of a ground system cannot be reused, and respective RRM and/or RLM measurement requirements may be determined based on the orbit heights of the satellites.

In the disclosure, after the terminal device determines the respective satellite types of the serving cell and the neighboring cell, the respective measurement requirements of the serving cell and the neighboring cell may be determined according to the satellite types, and the problem of different RRM and RLM requirements due to different orbits of the satellites is effectively solved.

FIG. 3 is a schematic flow diagram of a method for determining a satellite type of a cell provided by an example of the disclosure. The method is performed by a terminal device, and as shown in FIG. 3, the method includes:

S301, first indication information sent by a serving cell is received, where, the first indication information includes satellite types of the serving cell and a neighboring cell.

The first indication information is the indication information in the above-mentioned example.

In response to determining that the terminal device is in an idle state, the serving cell broadcasts a first SIB message to the terminal device, and accordingly, the terminal device may receive the first SIB message. The first SIB message is the first indication information, and the first SIB message includes a mapping relation between different cells and the satellite types.

In response to determining that the terminal device is in a connection state, the serving cell sends a first measurement object to the terminal device, and accordingly, the terminal device may receive the first measurement object. The first measurement object is the first indication information, and the first measurement object includes a mapping relation between different cells and the satellite types.

In some implementations, the different cells include the serving cell and/or the neighboring cell. In some other implementations, the different cells may include a cell under a carrier where the serving cell is located and/or a cell under a carrier where the neighboring cell is located.

S302, according to the first indication information, the satellite types of the serving cell and the neighboring cell where the terminal device is located are determined.

According to the mapping relation between the different cells and the satellite types in the first indication information, the satellite types of the serving cell and the neighboring cell where the terminal device is located are determined.

In some implementations, the terminal device simultaneously receives the first measurement object sent by the serving cell and the first SIB message broadcasted by the serving cell, and in response to determining that the satellite type corresponding to a target cell indicated by the first measurement object is inconsistent with the satellite type corresponding to a target cell indicated by the first SIB message, the satellite type corresponding to the target cell indicated by the first measurement object is determined as a final satellite type of the target cell.

The example of the disclosure provides the method for determining the satellite type of the cell, and the serving cell directly indicates the satellite types of the serving cell and the neighboring cell, such that the terminal device may determine the corresponding measurement requirements according to the satellite types.

FIG. 4 is a schematic flow diagram of a method for determining a satellite type of a cell provided by an example of the disclosure. The method is performed by a terminal device, and as shown in FIG. 4, the method includes:

S401, second indication information sent by a serving cell is received, where, the second indication information indicate a satellite type of the serving cell.

The second indication information is the indication information in the above-mentioned example.

In response to determining that the terminal device is in an idle state, the serving cell broadcasts a second SIB message to the terminal device, and accordingly, the terminal device may receive the second SIB message. The second SIB message is the second indication information, and the second SIB message includes a mapping relation between different cells under a carrier where the serving cell is located and the satellite types.

In response to determining that the terminal device is in a connection state, the serving cell sends a second measurement object to the terminal device, and accordingly, the terminal device may receive the second measurement object. The second measurement object is the second indication information, and the second measurement object includes a mapping relation between different cells under a carrier where the serving cell is located and the satellite types.

S402, third indication information sent by a neighboring cell is received, where, the third indication information indicate a satellite type of the neighboring cell.

The third indication information is the indication information in the above-mentioned example.

The third SIB message broadcasted by the neighboring cell is received from a carrier where the neighboring cell is located, where, the third SIB message is the third indication information, and the third SIB message includes a mapping relation between different cells under the carrier where the neighboring cell is located and the satellite types.

S403, according to the second indication information and the third indication information, the satellite types of the serving cell and the neighboring cell where the terminal device is located are determined.

According to the mapping relation in the second indication information, the satellite type of the serving cell is determined.

In some implementations, the terminal device simultaneously receives the second measurement object sent by the serving cell and the second SIB message broadcasted by the serving cell, and in response to determining that the satellite type corresponding to the serving cell indicated by the second measurement object is inconsistent with the satellite type corresponding to the serving cell indicated by the second SIB message, the satellite type corresponding to the serving cell indicated by the second measurement object is determined as a final satellite type of the serving cell.

According to the mapping relation in the third indication information, the satellite type of the neighboring cell is determined.

The example of the disclosure provides the method for determining the satellite type of the cell, and the serving cell and the neighboring cell respectively indicate the satellite types of the cells, such that the terminal device may determine the corresponding measurement requirements according to the satellite types.

FIG. 5 is a schematic flow diagram of a method for determining a satellite type of a cell provided by an example of the disclosure. The method is performed by a terminal device, and as shown in FIG. 5, the method includes:

S501, indication information is acquired.

S502, according to the indication information, satellite types of a serving cell and a neighboring cell where the terminal device is located are determined.

The specific implementation of steps S501 and S502 may refer to related instructions in the examples of the present disclosure, which is not repeated here.

S503, according to the satellite types of the serving cell and the neighboring cell, a radio resource management (RRM) requirement and/or a radio link monitoring (RLM) requirement arc/is performed on the serving cell and the neighboring cell.

Alternatively, a GEO satellite corresponds to a first type RRM requirement and a first type RLM requirement, an MEO satellite corresponds to a second type RRM requirement and a second type RLM requirement, an LEO satellite corresponds to a third type RRM requirement and a third type RLM requirement, and an HAPS satellite corresponds to a fourth type RRM requirement and a fourth type RLM requirement. According to the satellite types of the serving cell and the neighboring cell, the RRM requirements and RLM requirements of the serving cell and the neighboring cell are determined, and the serving cell and the neighboring cell are measured according to the requirements.

The first RRM requirement and/or the first RLM requirement corresponding to the satellite type of the serving cell are/is determined, and according to the first RRM requirement and the first RLM requirement, RRM measurement and/or RLM measurement is performed on the serving cell.

The second RRM requirement and/or the second RLM requirement corresponding to the satellite type of the neighboring cell are/is determined, and according to the second RRM requirement and the second RLM requirement, RRM measurement and RLM measurement is performed on the neighboring cell.

For example, the satellite type of the serving cell is the MEO satellite, it is determined that the first RRM requirement and/or the first RLM requirement is the second RRM requirement and the second RLM requirement, and according to the second type RRM requirement and the second type RLM requirement, RRM measurement and/or RLM measurement is performed on the serving cell. The satellite type of the neighboring cell is the LEO satellite, it is determined that the second RRM requirement and/or the second RLM requirement is the third type RRM requirement and the third type RLM requirement, and according to the third type RRM requirement and the third type RLM requirement, RRM measurement and/or RLM measurement is performed on the serving cell.

The RRM measurement requirement and RLM measurement requirement includes at least one of: a mobility requirement of a cell in an idle state or an inactive state, a mobility requirement of a cell in a connection state, a timing requirement, an RLM requirement, an interrupting requirement, a beam failure detection (BFD) assessment requirement, a candidate beam detection (CBD) assessment requirement or an RRM requirement.

The RRM measurement requirement and RLM measurement requirement is any combination of the above requirements, for example, includes the timing requirement, the RLM requirement, and the interrupting requirement, or includes the BFD assessment requirement, the CBD assessment requirement, and the RRM requirement. Moreover, the RRM measurement requirement and the RLM measurement requirement includes but is not limited to the above requirements.

The example of the disclosure provides the method for determining the satellite type of the cell, such that the terminal device may determine the RRM measurement requirement and RLM measurement requirement according to the satellite type, and the problem of different RRM requirements and RLM requirements due to different orbits of the satellites is effectively solved.

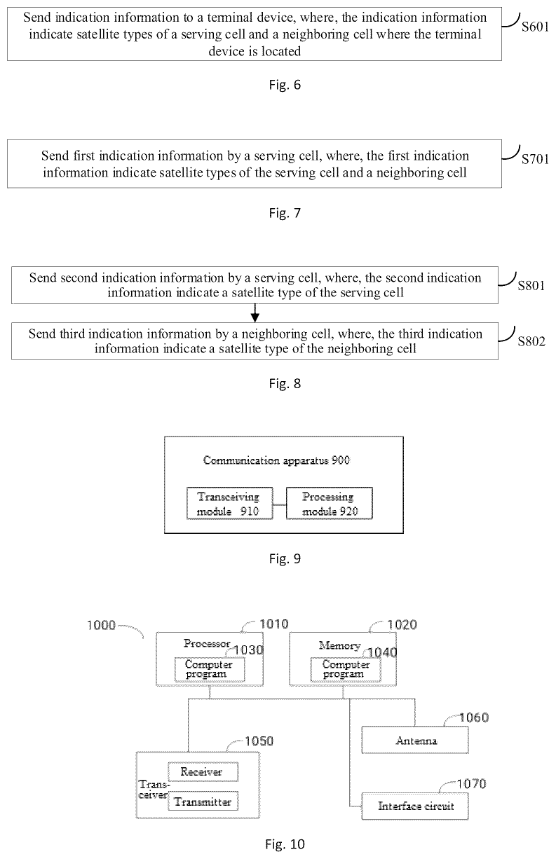

FIG. 6 is a schematic flow diagram of a method for determining a satellite type of a cell provided by an example of the disclosure. The method is performed by a network device, and as shown in FIG. 6, the method includes:

S601, indication information is sent to a terminal device, where, the indication information indicate satellite types of a serving cell and a neighboring cell where the terminal device is located.

In some implementations, the indication information is sent by the serving cell, and the indication information sent by the serving cell includes the satellite types of the serving cell and the neighboring cell.

In some other implementations, the indication information is sent by the serving cell and the neighboring cell separately, the indication information sent by the serving cell includes the satellite type of the serving cell, and the indication information sent by the neighboring cell includes the satellite type of the neighboring cell.

Alternatively, the serving cell may send different pieces of indication information according to a connection state of the terminal device. For example, when the terminal device is in an idle state, the serving cell may broadcast an SIB message to the terminal device, and when the terminal device is in the connection state, the serving cell may send a measurement object to the terminal device.

The example of the disclosure provides the method for determining the satellite type of the cell, by sending the indication information, the satellite types of the serving cell and the neighboring cell where the terminal device is located are indicated to the terminal device, such that the terminal device may determine the corresponding measurement requirements according to the satellite types.

FIG. 7 is a schematic flow diagram of a method for determining a satellite type of a cell provided by an example of the disclosure. The method is performed by a network device, and as shown in FIG. 7, the method includes:

S701, a serving cell sends first indication information, where, the first indication information indicate satellite types of the serving cell and a neighboring cell.

Alternatively, in response to determining that the terminal device is in an idle state, a network device of the serving cell broadcasts a first SIB message to the terminal device, where, the first SIB message is first indication information, and the first SIB message includes a mapping relation between different cells and the satellite types.

Alternatively, in response to determining that the terminal device is in a connection state, the network device of the serving cell sends a first measurement object to the terminal device, where, the first measurement object is first indication information, and the first measurement object includes a mapping relation between different cells and the satellite types.

In some implementations, the different cells include the serving cell and/or the neighboring cell. In some other implementations, the different cells may include a cell under a carrier where the serving cell is located and/or a cell under a carrier where the neighboring cell is located.

The example of the disclosure provides the method for determining the satellite type of the cell, by sending the first indication information, the satellite types of the serving cell and the neighboring cell where the terminal device is located are indicated to the terminal device, such that the terminal device may determine the corresponding measurement requirements according to the satellite types.

FIG. 8 is a schematic flow diagram of a method for determining a satellite type of a cell provided by an example of the disclosure. The method is performed by a network device, and as shown in FIG. 8, the method includes:

S801, a serving cell sends second indication information, where, the second indication information indicate a satellite type of the serving cell.

Alternatively, in response to determining that the terminal device is in an idle state, a network device of the serving cell broadcasts a second SIB message to the terminal device, where, the second SIB message is the second indication information, and the second SIB message includes a mapping relation between different cells under a carrier where the serving cell is located and the satellite types.

Alternatively, in response to determining that the terminal device is in a connection state, the network device of the serving cell sends a second measurement object to the terminal device, where, the second measurement object is the second indication information, and the second measurement object includes a mapping relation between different cells under a carrier where the serving cell is located and the satellite types.

S802, a neighboring cell sends third indication information, where, the third indication information indicate a satellite type of the neighboring cell.

A network device of the neighboring cell broadcasts a third SIB message to the terminal device, where, the third SIB message is the third indication information, and the third SIB message includes a mapping relation between under a carrier where the neighboring cell is located different cells and the satellite types.

The example of the disclosure provides the method for determining the satellite type of the cell, by sending the second indication information and the third indication information, the satellite types of the serving cell and the neighboring cell where the terminal device is located are indicated to the terminal device, such that the terminal device may determine the corresponding measurement requirements according to the satellite types.

In the example provided by the disclosure above, the method provided by the example of the disclosure is introduced respectively from the perspective of the network device and the terminal device. In order to implement functions in the method provided by the example of the disclosure, the network device and the terminal device may include a hardware structure and a software module, and the above functions are implemented in a form of the hardware structure, the software module, or the hardware structure and the software module. A certain function of the above functions may be executed in a form of the hardware structure, the software module, or the hardware structure and the software module.

Please refer to FIG. 9, which is a schematic structural diagram of a communication apparatus 900 provided by an example of the disclosure. The communication apparatus 900 shown in FIG. 9 may include a transceiving module 910 and a processing module 920. The transceiving module 910 may include a sending module and a receiving module, the sending module is configured to implement a sending function, the receiving module is configured to implement a receiving function, and the transceiving module 910 may implement the sending function and the receiving function.

The communication apparatus 900 may be a terminal device, may also be an apparatus in the terminal device, and may further be an apparatus capable of being matched with the terminal device for use. Alternatively, the communication apparatus 900 may be a network device, may also be an apparatus in the network device, and may further be an apparatus capable of being matched with the network device for use.

The communication apparatus 900 is the terminal device, and includes:

a transceiving module 910, configured to acquire indication information; and

a processing module 920, configured to determine satellite types of a serving cell and a neighboring cell where the terminal device is located according to the indication information.

Alternatively, the transceiving module 910 is further configured to receive first indication information sent by the serving cell, where, the first indication information includes the satellite types of the serving cell and the neighboring cell.

Alternatively, the transceiving module 910 is further configured to receive, in response to determining that the terminal device is in an idle state, a first SIB message broadcast by the serving cell, where, the first SIB message is the first indication information, and the first SIB message includes a mapping relation between different cells and the satellite types.

Alternatively, the transceiving module 910 is further configured to receive, in response to determining that the terminal device is in a connection state, a first measurement object sent by the serving cell, where, the first measurement object is the first indication information, and the first measurement object includes a mapping relation between different cells and the satellite types.

Alternatively, the processing module 920 is further configured to determine, in response to determining that the satellite type corresponding to a target cell indicated by the first measurement object is inconsistent with the satellite type corresponding to a target cell indicated by the first SIB message, the satellite type corresponding to the target cell indicated by the first measurement object as a final satellite type of the target cell.

Alternatively, the transceiving module 910 is further configured to receive second indication information sent by the serving cell, where, the second indication information is used for indicating the satellite type of the serving cell; and receive third indication information sent by the neighboring cell, where, the third indication information is used for indicating the satellite type of the neighboring cell.

Alternatively, the transceiving module 910 is further configured to receive, in response to determining that the terminal device is in the idle state, a second SIB message broadcasted by the serving cell, where, the second SIB message is the second indication information, and the second SIB message includes a mapping relation between different cells under a carrier where the serving cell is located and the satellite types.

Alternatively, the transceiving module 910 is further configured to receive, in response to determining that the terminal device is in the connection state, a second measurement object sent by the serving cell, where, the second measurement object is the second indication information, and the second measurement object includes a mapping relation between different cells under a carrier where the serving cell is located and the satellite types.

Alternatively, the processing module 920 is further configured to determine, in response to determining that the satellite type corresponding to a target cell indicated by the second measurement object is inconsistent with the satellite type corresponding to a target cell indicated by the second SIB message, the satellite type corresponding to the target cell indicated by the second measurement object as a final satellite type of the target cell.

Alternatively, the transceiving module 910 is further configured to receive a third SIB message broadcasted by the neighboring cell from a carrier where the neighboring cell is located, where, the third SIB message is third indication information, and the third SIB message includes a mapping relation between different cells under the carrier where the neighboring cell is located and the satellite types.

Alternatively, the processing module 920 is further configured to perform a radio resource management (RRM) requirement and/or a radio link monitoring (RLM) requirement on the serving cell and the neighboring cell according to the satellite types of the serving cell and the neighboring cell.

Alternatively, the processing module 920 is further configured to determine a first RRM requirement and/or a first RLM requirement corresponding to the satellite type of the serving cell, and execute RRM measurement and/or RLM measurement on the serving cell according to the first RRM requirement and a first RLM requirement; and determine a second RRM requirement and/or a second RLM requirement corresponding to the satellite type of the neighboring cell, and execute RRM measurement and RLM measurement on the neighboring cell according to the second RRM requirement and the second RLM requirement.

Alternatively, the RRM measurement requirement and the RLM measurement requirement includes at least one of: a mobility requirement of a cell in an idle state or an inactive state; a mobility requirement of a cell in a connection state; a timing requirement; an RLM requirement; an interrupting requirement; a beam failure detection (BFD) assessment requirement; a candidate beam detection (CBD) assessment requirement; or an RRM requirement.

The communication apparatus 900 is the network device, and includes:

a transceiving module 910, configured to send indication information to the terminal device, where, the indication information is used for indicating the satellite types of the serving cell and the neighboring cell where the terminal device is located.

Alternatively, the transceiving module 910 is further configured to determine the terminal device being in an idle state, and broadcast a first SIB message to the terminal device, where, the first SIB message includes a mapping relation between different cells and the satellite types.

Alternatively, the transceiving module 910 is further configured to determine the terminal device being in a connection state, and send a first measurement object to the terminal device, where, the first measurement object includes a mapping relation between different cells and the satellite types.

Alternatively, the transceiving module 910 is further configured to send, in response to determining that the network device is a network device of the serving cell, second indication information to the terminal device, where, the second indication information is used for indicating the satellite type of the serving cell; and send, in response to determining that the network device is a network device of the neighboring cell, third indication information to the terminal device, where, the third indication information is used for indicating the satellite type of the neighboring cell.

Alternatively, the transceiving module 910 is further configured to send, in response to determining that the terminal device is in the idle state, a second SIB message broadcasted to the terminal device, where, the second SIB message is the second indication information, and the second SIB message includes a mapping relation between different cells under a carrier where the serving cell is located and the satellite types.

Alternatively, the transceiving module 910 is further configured to send, in response to determining that the terminal device is in the connection state, a second measurement object to the terminal device, where, the second measurement object is the second indication information, and the second measurement object includes a mapping relation between different cells under a carrier where the serving cell is located and the satellite types.

Alternatively, the transceiving module 910 is further configured to broadcast a third SIB message to the terminal device, where, the third SIB message is the third indication information, and the third SIB message includes a mapping relation between different cells under the carrier where the neighboring cell is located and the satellite types.

Alternatively, the RRM and RLM measurement requirement includes at least one of: a mobility requirement of a cell in an idle state or an inactive state; a mobility requirement of a cell in a connection state; a timing requirement; an RLM requirement; an interrupting requirement; a beam failure detection (BFD) assessment requirement; a candidate beam detection (CBD) assessment requirement; or an RRM requirement.

Please refer to FIG. 10, which is a schematic structural diagram of another communication apparatus 1000 provided by an example of the disclosure. The communication apparatus 1000 may be a network device, may also be a terminal device, may also be a chip, a chip system or a processor, etc. supporting the network device to implement the above method, and may further be a chip, a chip system, or a processor, etc. supporting the terminal device e to implement the above method. The apparatus may be configured to implement the method described in the examples of the method above, and specifically may refer to the illustration in the examples of the method above.

The communication apparatus 1000 may include one or a plurality of processors 1010. The processor 1010 may be a general-purpose processor or a dedicated processor. For example, the processor 1010 may be a baseband processor or a central processor. The baseband processor may be configured to process a communication protocol and communication data, the central processor may be configured to control the communication apparatus (such as a base station, a base band chip, a terminal device, a terminal device chip, a DU or a CU, etc.), execute computer programs, and process data of the computer programs.

Alternatively, the communication apparatus 1000 may further include one or a plurality of memories 1020, a computer program 1040 may be stored on the memory 1020, and the processor 1010 executes the computer program 1040, such that the communication apparatus 1000 executes the method described in the example of the above method. Alternatively, data may further be stored in the memory 1020. The communication apparatus 1000 and the memory 1020 may be arranged separately, and may also be integrated together.

Alternatively, the communication apparatus 1000 may further include a transceiver 1050 and an antenna 1060. The transceiver 1050 may be called a transceiving unit, a transmitter receiver, or a transceiver, etc., for implementing a transceiving function. The transceiver 1050 may include a receiver and a transmitter, and the receiver may be called a receiving machine or a receiving circuit, etc., for implementing a receiving function; and the transmitter may be called a sending machine or a sending circuit, etc., for implementing a sending function.

Alternatively, the communication apparatus 1000 may further include one or a plurality of interface circuits 1070. The interface circuit 1070 is configured to receive code instructions and transmit the code instructions to the processor 1010. The processor 1010 runs the code instructions to make the communication apparatus 1000 execute the method described in the examples of the method above.

In one implementation, the processor 1010 may include a transceiver for implementing receiving and sending functions. For example, the transceiver may be a transceiving circuit, or an interface, or an interface circuit. The transceiving circuit, the interface, or the interface circuit for implementing receiving and sending functions may be separated, and may also be integrated together. The above transceiving circuit, the interface, or the interface circuit may be configured to read and write codes/data, alternatively, the above transceiving circuit, the interface, or the interface circuit may be configured to transmit or transfer signals.

In one implementation, the processor 1010 may store a computer program 1030, and the computer program 1030 runs on the processor 1010, such that the communication apparatus 1000 executes the method described in the examples of the method above. The computer program 1030 may be solidified on the processor 1010, and in this case, the processor 1010 may be implemented by hardware.

In one implementation, the communication apparatus 1000 may include a circuit, and the circuit may implement functions of sending or receiving or communication in the examples of the above-mentioned method. The processor and transceiver described in the disclosure may be implemented on an integrated circuit (IC), an analog IC, a radio frequency integrated circuit (RFIC), a mixed signal IC, an application specific integrated circuit (ASIC), a printed circuit board (PCB), an electronic device, etc. The processor and transceiver may also be manufactured by using various IC process technologies, for example, a complementary metal oxide semiconductor (CMOS), an nMetal-oxide-semiconductor (NMOS), a positive channel metal oxide semiconductor (PMOS), a bipolar junction transistor (BJT), a BICMOS, SiGe, GaAs, etc.

The communication apparatus described in the above example may be a network device or a terminal device, however, the scope of the communication apparatus described in the disclosure is not limited to this, and the structure of the communication apparatus may not be limited by FIG. 10. The communication apparatus may be a separate device or a part of a larger device. For example, the communication apparatus may be:

(1) a separate integrated circuit IC, or a chip, or a chip system or a subsystem;

(2) a collection having one or more ICs, alternatively, the IC collection may also include a storing component for storing data and computer programs;

(3) an ASIC, such as a modem;

(4) a module capable of being embedded into other devices;

(5) a receiver, a terminal device, an intelligent terminal device, a cellular phone, a wireless device, a handset, a mobile unit, a vehicle device, a network device, a cloud device, artificial intelligence equipment, etc.; and

(6) others, etc.

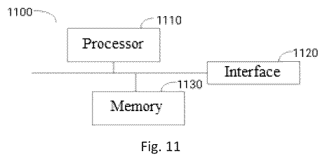

For the condition that the communication apparatus may be the chip or the chip system, please refer to a schematic structural diagram of a chip shown in FIG. 11. The chip shown in FIG. 11 includes a processor 1110 and an interface 1120. The quantity of the interface 1120 may be one or more, and the quantity of the processor 1110 may be more.

Alternatively, the chip may further include a memory 1130, and the memory 1130 is configured to store needful computer programs and data.

Those skilled in the art may further know that various illustrative logical blocks and steps listed in the examples of the disclosure may be implemented by electronic hardware, computer software, or a combination of two. Whether the functions are implemented through hardware or software depends on specific application and design requirements of the whole system. Those skilled in the art may use various methods to implement the functions for each specific application, however, the implementation will not be understood as exceeding the scope of protection of the example of the disclosure.

An example of the disclosure further provides a system for determining a satellite type of a cell. The system includes the communication apparatus as the terminal device and the communication apparatus as the network device in the example of FIG. 9 above-mentioned, and alternatively, the system includes the communication apparatus as the terminal device and the communication apparatus as the network device in the example of FIG. 10 above-mentioned.

The disclosure further provides a readable storage medium, storing an instruction, and the instruction, when executed by a computer, implements the function of the example of any method above.

The disclosure further provides a computer program product, and the computer program product, when executed by a computer, implements the function of the example of any method above.

The above examples may be all or partially implemented through software, hardware, firmware, or any combination. When implementing by using the software, the form of all or partially using the computer program product may be used. The computer program product includes one or more computer programs. When the computer programs are loaded and executed on the computer, flows and functions described according to the example of the disclosure are all or partially generated. The computer may be a general-purpose computer, a dedicated computer, a computer network, or other programmable apparatuses. The computer programs may be stored in the computer readable storage medium, or may be transmitted from one computer readable storage medium to another computer readable storage medium, for example, the computer programs may be transmitted from one website point, a computer, a server or a data center to another website point, a computer, a server or a data center through a wired (such as a coaxial cable, an optical fiber, a digital subscriber line (DSL)) or wireless (such as infrared, wireless, microwave, etc.) mode. The computer readable storage medium may be any available medium capable of being stored by the computer or a server, a data center and data storage devices containing one or more available medium integrations. The available medium may be a magnetic medium (such as a soft disk, a hard disk, a magnetic tape), an optical medium (such as a high-density digital video disc (DVD)), or a semiconductor medium (such as a solid state disk (SSD), etc.

Those ordinarily skilled in the art may understand that first, second and various numerical symbols involved in the disclosure are merely distinguished for facilitating describing, and do not limit the scope of the examples of the disclosure, and a sequential order is also not indicated.

“At least one” in the disclosure may further be described as one or a plurality of, “a plurality of” may be two, three, four or more, and the disclosure does not limit them. In the example of the disclosure, for one technical feature, by using “first”, “second”, “third”, “A”, “B”, “C”, “D”, etc. to distinguish the technical feature in the technical feature, and the technical feature described in the “first”, “second”, “third”, “A”, “B”, “C” and “D” has no sequential order or order of size.

An example of the disclosure provides a method and apparatus for determining a satellite type of a cell. Satellite types of a serving cell and a neighboring cell where a terminal device is located are acquired through indication information, such that the terminal device may determine corresponding measurement requirements according to the satellite types.

In a first aspect, an example of the disclosure provides a method for determining a satellite type of a cell, performed by a terminal device, and including: acquiring indication information; and determining satellite types of a serving cell and a neighboring cell where the terminal device is located through the indication information.

In a second aspect, an example of the disclosure provides a method for determining a satellite type of a cell, performed by a network device, and including: sending indication information to a terminal device, where, the indication information indicate satellite types of a serving cell and a neighboring cell where the terminal device is located.

In a third aspect, an example of the disclosure provides a communication apparatus. The communication apparatus has part or all functions for implementing the terminal device in the method described in the first aspect above, for example, the communication apparatus may have functions of part or all examples in the disclosure, and may also have functions of independently implementing any example in the disclosure. The functions may be implemented through hardware, and may also be implemented through hardware executing corresponding software. The hardware or software includes one or more units or modules corresponding to the above functions.

In one implementation, the communication apparatus may include a transceiving module and a processing module, and the processing module is configured to support the communication apparatus to execute corresponding functions in the above method. The transceiving module is configured to support communication between the communication apparatus and other devices. The communication apparatus may further include a storage module, and the storage module is configured to be coupled with the transceiving module and the processing module, and stores needful computer programs and data for the communication apparatus.

As an example, the processing module may be a processor, the transceiving module may be a transceiver or a communication interface, and the storage module may be a memory.

In a fourth aspect, an example of the disclosure provides another communication apparatus. The communication apparatus has part or all functions for implementing the network device in the method example described in the second aspect above, for example, the communication apparatus may have functions of part or all examples in the disclosure, and may also have functions of independently implementing any example in the disclosure. The functions may be implemented through hardware, and may also be implemented through hardware executing corresponding software. The hardware or software includes one or more units or modules corresponding to the above functions.

In one implementation, the communication apparatus may include a transceiving module and a processing module, and the processing module is configured to support the communication apparatus to execute corresponding functions in the above method. The transceiving module is configured to support communication between the communication apparatus and other devices. The communication apparatus may further include a storage module, and the storage module is configured to be coupled with the transceiving module and the processing module, and stores needful computer programs and data for the communication apparatus.

As an example, the processing module may be a processor, the transceiving module may be a transceiver or a communication interface, and the storage module may be a memory.

In a fifth aspect, an example of the disclosure provides a communication apparatus. The communication apparatus includes a processor, and the processor, when calling a computer program in a memory, executes the method described in the first aspect above.

In a sixth aspect, an example of the disclosure provides a communication apparatus. The communication apparatus includes a processor, and the processor, when calling a computer program in a memory, executes the method described in the second aspect above.

In a seventh aspect, an example of the disclosure provides a communication apparatus. The communication apparatus includes a processor and a memory, and the memory stores a computer program; and the processor, when executing the computer program stored in the memory, causes the communication apparatus to execute the method described in the first aspect above.

In an eighth aspect, an example of the disclosure provides a communication apparatus. The communication apparatus includes a processor and a memory, and the memory stores a computer program; and the processor, when executing the computer program stored in the memory, causes the communication apparatus to execute the method described in the second aspect above.

In a ninth aspect, an example of the disclosure provides a communication apparatus. The communication apparatus includes a processor and an interface circuit, the interface circuit is configured to receive a code instruction and transmit the code instruction to the processor, and the processor is configured to run the code instruction to cause the apparatus to execute the method described in the first aspect above.

In a tenth aspect, an example of the disclosure provides a communication apparatus. The communication apparatus includes a processor and an interface circuit, the interface circuit is configured to receive a code instruction and transmit the code instruction to the processor, and the processor is configured to run the code instruction to cause the apparatus to execute the method described in the second aspect above.

In an eleventh aspect, an example of the disclosure provides a communication system. The system includes the communication apparatus described in the third aspect and the communication apparatus described in the fourth aspect, or, the system includes the communication apparatus described in the fifth aspect and the communication apparatus described in the sixth aspect, or, the system includes the communication apparatus described in the seventh aspect and the communication apparatus described in the eighth aspect, or, the system includes the communication apparatus described in the ninth aspect and the communication apparatus described in the tenth aspect.

In a twelfth aspect, an example of the disclosure provides a non-transitory computer readable storage medium, configured to store instructions for the above terminal device, and when the instructions are executed, the terminal device executes the method in the first aspect above.

In a thirteenth aspect, an example of the disclosure provides a non-transitory computer readable storage medium, configured to store instructions for the above network device, and when the instructions are executed, the network device executes the method in the second aspect above.

In a fourteenth aspect, the disclosure further provides a computer program product including a computer program, and when the computer program runs on a computer, the computer executes the method in the first aspect above.

In a fifteenth aspect, the disclosure further provides a computer program product including a computer program, and when the computer program runs on a computer, the computer executes the method in the second aspect above.

In a sixteenth aspect, the disclosure provides a chip system, the chip system includes at least one processor and an interface, configured to support a terminal device to implement functions involved in the first aspect, for example, determining or processing at least one of data and information involved in the above method. In a possible design, the chip system further includes a memory, and the memory is configured to store needful computer programs and data for the terminal device. The chip system may be composed of chips, and may also include chips and other discrete devices.

In a seventeenth aspect, the disclosure provides a chip system, the chip system includes at least one processor and an interface, configured to support a network device to implement functions involved in the second aspect, for example, determining or processing at least one of data and information involved in the above method. In a possible design, the chip system further includes a memory, and the memory is configured to store needful computer programs and data for the network device. The chip system may be composed of chips, and may also include chips and other discrete devices.

In an eighteenth aspect, the disclosure provides a computer program, and when the computer program runs on a computer, the computer executes the method in the first aspect above.

In a nineteenth aspect, the disclosure provides a computer program, and when the computer program runs on a computer, the computer executes the method in the second aspect above.

A corresponding relation shown in figures of the disclosure may be configured, and may also be predefined. Values of information in the figures are merely illustrative, other values may be configured, and the disclosure does not limit them. When configuring a corresponding relation of the information and parameters, all corresponding relations illustrated in the figures do not need to be configured. For example, in tables of the disclosure, some corresponding relations illustrated in the figures may also not be configured. For another example, appropriate transformation adjustment may be performed based on the above tables, for example, splitting, merging, etc. Names of parameters shown in titles of the above tables may also adopt other names understood by the communication apparatus, and values or an expression mode of the parameters may also adopt other values or expression modes understood by the communication apparatus. When the above tables are implemented, other data structures may also be adopted, for example, adopting an array, a queue, a container, a stack, a linear list, a pointer, a linked list, a tree, a diagram, a structural body, a kind, a pile, a hash table or a hash table, etc.

The “predefining” in the disclosure may be understood as defining, predefining, storage, pre-storage, pre-consulting, pre-configuration, firming, or pre-firing.

Those ordinarily skilled in the art may realize that in conjunction with units and arithmetic steps of examples described in the examples of the present disclosure in the context, implementing may be achieved by electronic hardware, or a combination of computer software and electronic hardware. Whether these functions are executed in a hardware mode or a software mode depends on specific application and design constraint conditions of the technical solution. Professional technical personnel may use different methods to implement the described functions for each specific application, however, this implementation may not be understood exceeding the scope of the disclosure.

Those ordinarily skilled in the art may clearly understand that for convenient and concise description, the above described system, apparatus and specific working process of units may refer to the corresponding process in the examples of the above-mentioned method, which is not repeated here.

In conclusion, as the specific implementation of the disclosure, the protection scope of the disclosure is not limited to this, any person ordinarily skilled in the art familiar with the technical field can easily think of changes or replacements within the technical scope disclosed in the disclosure, which can be covered within the protection scope of the disclosure. Thus, the protection scope of the disclosure will be governed by the protection scope of the claims.

1. A method for determining a satellite type of a cell, performed by a terminal device and comprising:
acquiring indication information; and
determining satellite types of a serving cell and a neighboring cell where the terminal device is located according to the indication information.

2. The method according to claim 1, wherein acquiring the indication information comprises:
receiving first indication information sent by the serving cell, wherein the first indication information comprises the satellite types of the serving cell and the neighboring cell.

3. The method according to claim 2, further comprising at least one of:
receiving, in response to determining that the terminal device is in an idle state, a first system information block (SIB) message broadcasted by the serving cell, wherein the first SIB message is the first indication information, and the first SIB message comprises a mapping relation between different cells and the satellite types; or
receiving, in response to determining that the terminal device is in a connection state, a first measurement object sent by the serving cell, wherein the first measurement object is the first indication information, and the first measurement object comprises a mapping relation between different cells and the satellite types.

4. (canceled)

5. The method according to claim 3, further comprising:
determining, in response to determining that the satellite type corresponding to a target cell indicated by the first measurement object is inconsistent with the satellite type corresponding to a target cell indicated by the first SIB message, the satellite type corresponding to the target cell indicated by the first measurement object as a final satellite type of the target cell.

6. The method according to claim 1, wherein acquiring the indication information comprises:
receiving second indication information sent by the serving cell, wherein the second indication information indicate the satellite type of the serving cell; and
receiving third indication information sent by the neighboring cell, wherein the third indication information indicate the satellite type of the neighboring cell.

7. The method according to claim 6, wherein acquiring the indication information comprises at least one of:
receiving, in response to determining that the terminal device is in an idle state, a second SIB message broadcasted by the serving cell, wherein the second SIB message is the second indication information, and the second SIB message comprises a mapping relation between different cells under a carrier where the serving cell is located and the satellite types; or
receiving, in response to determining that the terminal device is in a connection state, a second measurement object sent by the serving cell, wherein the second measurement object is the second indication information, and the second measurement object comprises a mapping relation between different cells under a carrier where the serving cell is located and the satellite types.

8. (canceled)

9. The method according to claim 7, further comprising:
determining, in response to determining that the satellite type corresponding to a target cell indicated by the second measurement object is inconsistent with the satellite type corresponding to a target cell indicated by the second SIB message, the satellite type corresponding to the target cell indicated by the second measurement object as a final satellite type of the target cell.

10. The method according to claim 6, wherein acquiring the indication information comprises:
receiving a third SIB message broadcasted by the neighboring cell from a carrier where the neighboring cell is located, wherein the third SIB message is the third indication information, and the third SIB message comprises a mapping relation between different cells under a carrier where the neighboring cell is located and the satellite types.

11. The method according to any one of claim 1, wherein, after determining the satellite types of the serving cell and the neighboring cell where the terminal device is located, the method further comprises:
performing, according to the satellite types of the serving cell and the neighboring cell, at least one of a radio resource management (RRM) requirement or a radio link monitoring (RLM) requirement on the serving cell and the neighboring cell.

12. The method according to claim 11, wherein performing, according to the indication information of the satellite types, at least one of the radio resource management (RRM) requirement or the radio link monitoring (RLM) requirement on the serving cell and the neighboring cell comprises:
determining at least one of a first RRM requirement or a first RLM requirement corresponding to the satellite type of the serving cell, and performing RRM measurement or RLM measurement on the serving cell according to the first RRM requirement or the first RLM requirement; and
determining at least one of a second RRM requirement or a second RLM requirement corresponding to the satellite type of the neighboring cell, and performing RRM measurement and RLM measurement on the neighboring cell according to the second RRM requirement and the second RLM requirement.

13. The method according to claim 11, wherein the RRM requirement and RLM requirement comprises at least one of:
a mobility requirement of a cell in an idle state or an inactive state;
a mobility requirement of a cell in a connection state;
a timing requirement;
an RLM requirement;
an interrupting requirement;
a beam failure detection (BFD) assessment requirement;
a candidate beam detection (CBD) assessment requirement; or
an RRM requirement.

14. A method for determining a satellite type of a cell, performed by a network device and comprising:
sending indication information to a terminal device, wherein the indication information indicate satellite types of a serving cell and a neighboring cell where the terminal device is located.

15. The method according to claim 14, wherein sending the indication information to the terminal device comprises at least one of:
sending, in response to determining that the terminal device is in an idle state, a first SIB message broadcasted by a network device of the serving cell to the terminal device, wherein the first SIB message comprises a mapping relation between different cells and the satellite types; or
sending, in response to determining that the terminal device is in a connection state, a first measurement object sent by a network device of the serving cell to the terminal device, wherein the first measurement object comprises a mapping relation between different cells and the satellite types.

16. (canceled)

17. The method according to claim 15, wherein sending the indication information to the terminal device comprises:
sending, in response to determining that the network device is a network device of the serving cell, second indication information to the terminal device, wherein the second indication information indicate the satellite type of the serving cell; and
sending, in response to determining that the network device is a network device of the neighboring cell, third indication information to the terminal device, wherein the third indication information indicate the satellite type of the neighboring cell.

18. The method according to claim 17, wherein sending the second indication information to the terminal device comprises at least one of:
sending, in response to determining that the terminal device is in the idle state, a second SIB message broadcasted by the network device of the serving cell to the terminal device, wherein the second SIB message is the second indication information, and the second SIB message comprises a mapping relation between different cells under a carrier where the serving cell is located and the satellite types; or
sending, in response to determining that the terminal device is in the connection state, a second measurement object sent by the network device of the serving cell to the terminal device, wherein the second measurement object is the second indication information, and the second measurement object comprises a mapping relation between different cells under a carrier where the serving cell is located and the satellite types.

19. (canceled)

20. The method according to claim 17, wherein sending the third indication information to the terminal device comprises:
broadcasting a third SIB message by the network device of the neighboring cell to the terminal device, wherein the third SIB message is the third indication information, and the third SIB message comprises a mapping relation between different cells under the carrier where the neighboring cell is located and the satellite types.

21. The method according to claim 15, wherein a radio resource management (RRM) requirement and a radio link monitoring (RLM) requirement of the serving cell and the neighboring cell comprises at least one of:
a mobility requirement of a cell in an idle state or an inactive state;
a mobility requirement of a cell in a connection state;
a timing requirement;
an RLM requirement;
an interrupting requirement;
a beam failure detection (BFD) assessment requirement;
a candidate beam detection (CBD) assessment requirement; or
an RRM requirement.

22. A communication apparatus, comprising one or more processors and a memory, and the one or more processors is/are configured to:
acquire indication information; and
determine satellite types of a serving cell and a neighboring cell where a terminal device is located according to the indication information.

23-27. (canceled)

28. A non-transitory computer readable storage medium, configured to store an instruction, wherein the instruction, when performed, implements the method according to claim 1.

29. A non-transitory computer readable storage medium, configured to store an instruction, wherein the instruction, when performed, implements the method according to claim 14.
